(19) United States
(12) Patent Application Publication
(10) Pub. No.: US 2024/0167600 A1
(43) Pub. Date: May 23, 2024

(54) QUICK-CONNECT PIPE COUPLING

(71) Applicants: James Dean SNOW, Novi, MI (US); ABC TECHNOLOGIES INC., Toronto, Ontario (CA)

(72) Inventors: James Dean SNOW, Novi, MI (US); Jeffery S. MOORE, LaSalle, Ontario (CA); Kevin THEUMA, Toronto, Ontario (CA); Brian SUNLEY, Mississauga, Ontario (CA); Mo XU, Thornhill, Ontario (CA)

(21) Appl. No.: 18/549,226

(22) PCT Filed: Mar. 8, 2022
(86) PCT No.: PCT/US2022/019331

§ 371 Date: Sep. 6, 2023

Related U.S. Application Data
(60) Provisional application No. 63/158,418, filed on Mar. 9, 2021.

(51) Int. Cl. F16L 37/088; F16L 37/14

(52) U.S. Cl. CPC F16L 37/0885; F16L 37/144

(57) ABSTRACT

A coupling for interconnecting sections of pipe. The coupling includes a first pipe element having a first coupling member in the form of a female socket, and a second pipe element having a second coupling member in the form of a male plug. The socket of the first pipe element is dimensioned to receive therein the plug of the second pipe element. The coupling also includes a seal interface to prevent passage of air or fluids through an annular gap between the socket of the first coupling member and the plug of the second coupling member. The seal interface includes a sealing element and a sealing element retainer. The sealing element retainer is positioned internally of the coupling, within a cylindrical cavity of the socket.

### FIELD

The present invention pertains to pipe couplings, and in particular to a pipe coupling that permits for lockable quick-connect functionality.

### BACKGROUND

The automotive engine compartment is a complex environment with limited real estate available for the required components in a modern high efficiency engine. A particular challenge arises for the air induction system, which requires a network of air induction conduits that can be securely positioned and sealed in a manner that prevents the unwanted ingress/egress of air, water and debris. In particular, the air induction system is subject to certain degrees to movement and vibration that places a general strain upon the system.

The conduit network of the air induction system typically employs connectors to facilitate assembly of the individual components. Connectors of the quick-connect variety are especially useful, as they aid in the assembly of the system by providing a simple press fit connection. Connectors of this type are known, but are often provided as separate structures that are added to conduits during the assembly process. This adds additional steps to the assembly process, increasing process complexity and overall assembly time.

Accordingly, there is a need for a conduit assembly that employs a coupler of the quick-connect variety that is simpler in construction, and is sufficiently robust to withstand the rigors of the engine compartment during use.

### SUMMARY

According to a first embodiment hereof, the present disclosure provides a coupling for interconnecting sections of pipe. The coupling includes a first pipe element having a first coupling member in the form of a female socket, and a second pipe element having a second coupling member in the form of a male plug. The socket of the first pipe element is dimensioned to receive therein the plug of the second pipe element. The coupling also includes a seal interface to prevent passage of air or fluids through an annular gap between the socket of the first coupling member and the plug of the second coupling member. The seal interface includes a sealing element and a sealing element retainer. The sealing element retainer is positioned internally of the coupling, within a cylindrical cavity of the socket.

In an aspect of the first embodiment, and in combination with any other aspects herein, the disclosure provides that the cylindrical cavity of the socket is located adjacent a first cylindrical portion of the first pipe element. The cylindrical cavity includes a divergent frustoconical wall and a second cylindrical portion. The socket includes a seal pocket at a transition between the frustoconical wall and the second cylindrical portion.

In an aspect of the first embodiment, and in combination with any other aspects herein, the disclosure provides that the sealing element retainer serves to maintain the sealing element under compression within the socket of the first coupling member independent of whether the plug of the second coupling member is coupled in position.

In an aspect of the first embodiment, and in combination with any other aspects herein, the disclosure provides that the sealing element retainer serves to maintain the sealing element under compression within the socket to promote sealing engagement between a portion of the sealing element and one or more surfaces of the seal pocket.

In an aspect of the first embodiment, and in combination with any other aspects herein, the disclosure provides that the sealing element includes a first sealing finger and a second sealing finger, the first sealing finger being arranged to engage and seal against one or more surfaces of the seal pocket of the socket, and the second sealing finger being arranged to engage and seal against an outer peripheral surface of the plug when the coupling is in a fully assembled state.

In an aspect of the first embodiment, and in combination with any other aspects herein, the disclosure provides that the sealing element and the sealing element retainer are generally annular in configuration, with the sealing element retainer having a retainer main body, a sealing engagement surface that engages a corresponding portion of the sealing element, and a retainer lock. In an embodiment, the retainer lock of the sealing element retainer is a discontinuous annular structure, having a plurality of separated retainer lock segments, and each of the separated retainer lock segments correspond to and seats within a respective retainer lock opening provided in the socket of the first coupling member.

In an aspect of the first embodiment, and in combination with any other aspects herein, the disclosure provides that the first and second coupling members are integrally formed to the respective first and second pipe elements.

In an aspect of the first embodiment, and in combination with any other aspects herein, the disclosure provides that the first and second coupling members are separately formed, and subsequently attached to the respective first and second pipe elements.

In an aspect of the first embodiment, and in combination with any other aspects herein, the disclosure provides that the coupling further includes a releasable locking mechanism to prevent inadvertent removal of the plug from the socket. In an embodiment, the releasable locking mechanism includes a locking ring that includes locking portions that pass through corresponding slits on the socket to extend into the cylindrical cavity. The locking portions engage a corresponding lock feature provided on the plug.

According to a second embodiment hereof, the present disclosure provides a process for the installation of an annular sealing element in a first pipe element. A first pipe element having a female socket is arranged in a fixture. The first pipe element is positioned in a manner that aligns the socket to face a plunger mechanism. An annular sealing member is inserted into the socket. A sealing element retainer is placed within the socket in a manner that axially aligns a series of retainer lock elements with a corresponding retainer lock opening of the socket. A slide actuator of the fixture is used to compress the retainer lock segments radially inwards sufficiently to temporarily clear an inside diameter of the socket. The plunger mechanism is axially displaced so as to seat the sealing element retainer against the annular sealing element, sealing element retainer being fully locked when each of the retainer lock segments spring into their original position, and are seated within the corresponding retainer lock opening of the socket. The plunger mechanism is retracted from the socket, and the first pipe element is removed from the fixture.

### BRIEF DESCRIPTION OF THE DRAWINGS

The foregoing and other features and advantages of the invention will be apparent from the following description of embodiments thereof as illustrated in the accompanying drawings. The accompanying drawings, which are incorporated herein and form a part of the specification, further serve to explain the principles of the invention and to enable a person skilled in the pertinent art to make and use the invention. The drawings are not to scale.

FIG. 1 is an exploded perspective view of the coupling in accordance with an embodiment of the invention.

FIG. 2 is a perspective view of the coupling according to the embodiment of FIG. 1, showing the coupling in an uncoupled state.

FIG. 3 is a perspective view of the coupling according to the embodiment of FIG. 1, showing the coupling in a coupled state.

FIG. 4 is a side sectional view and an inset close-up view of the socket forming part of the coupling according to the embodiment of FIG. 1. The sealing element and retainer are removed from the socket for clarity. The sectional view is taken through the retainer lock opening.

FIG. 5 is a side sectional view of the plug forming part of the coupling according to the embodiment of FIG. 1.

FIG. 6 is a partial side sectional view of the coupling according to the embodiment of FIG. 1, the coupling shown in a coupled state. The sectional view is taken through the retainer lock opening to highlight features of the seal interface.

FIG. 7 is a close-up partial side sectional view of the seal interface forming part of the coupling according to the embodiment of FIG. 1, the seal interface shown in the coupled state. The sectional view is taken through the retainer lock opening to highlight features of the seal interface.

FIG. 8a is a perspective view of the sealing element forming part of the coupling according to the embodiment of FIG. 1.

FIG. 8b is an end-on view of the sealing element of FIG. 8a, the sealing element forming part of the coupling according to the embodiment of FIG. 1.

FIG. 8c is a sectional profile view of the sealing element of FIG. 8a through A-A (noted in FIG. 8b), the sealing element forming part of the coupling according to the embodiment of FIG. 1.

FIG. 9a is a perspective view of the retainer forming part of the coupling according to the embodiment of FIG. 1.

FIG. 9b is an end-on view of the retainer of FIG. 9a, the retainer forming part of the coupling according to the embodiment of FIG. 1.

FIG. 9c is a sectional profile view of the retainer of FIG. 9a through B-B (noted in FIG. 9b), the retainer forming part of the coupling according to the embodiment of FIG. 1.

FIG. 10 is a close-up partial side sectional view of the seal interface forming part of the coupling according to the embodiment of FIG. 1, the seal interface shown in an uncoupled state. The sectional view is taken through the retainer lock opening to highlight features of the seal interface.

FIG. 11 is a partial side sectional view of the coupling according to the embodiment of FIG. 1, the section providing details on the releasable locking mechanism, the coupling shown in a coupled state. The sectional view is taken through the slits of the releasable locking mechanism, to highlight features thereof.

FIG. 12 is perspective view of the socket forming part of the coupling according to the embodiment of FIG. 1, the view excluding the sealing element and retainer for clarity.

FIG. 13 is a terminal end view of the socket forming part of the coupling according to the embodiment of FIG. 1, detailing aspects of the locking ring in relation to the cylindrical cavity.

FIGS. 14a through 14f illustrate assembly details for the socket forming part of the coupling according to the embodiment of FIG. 1.

FIG. 15 shows an alternative fixture for the assembly of the socket forming part of the coupling according to the embodiment of FIG. 1, the alternative fixture including a ‘poke-yoke’ feature.

FIG. 16 shows additional detail on the alternative fixture of FIG. 15.

### DETAILED DESCRIPTION

Specific embodiments of the present disclosure will now be described with reference to the Figures, wherein like reference numbers indicate identical or functionally similar elements. The following detailed description is merely exemplary in nature and is not intended to limit the disclosure or the application and uses of the disclosure. A person skilled in the relevant art will recognize that other configurations and arrangements can be used without departing from the scope of the disclosure. Furthermore, there is no intention to be bound by any expressed or implied theory presented in the preceding technical field, background, brief summary, or the following detailed description.

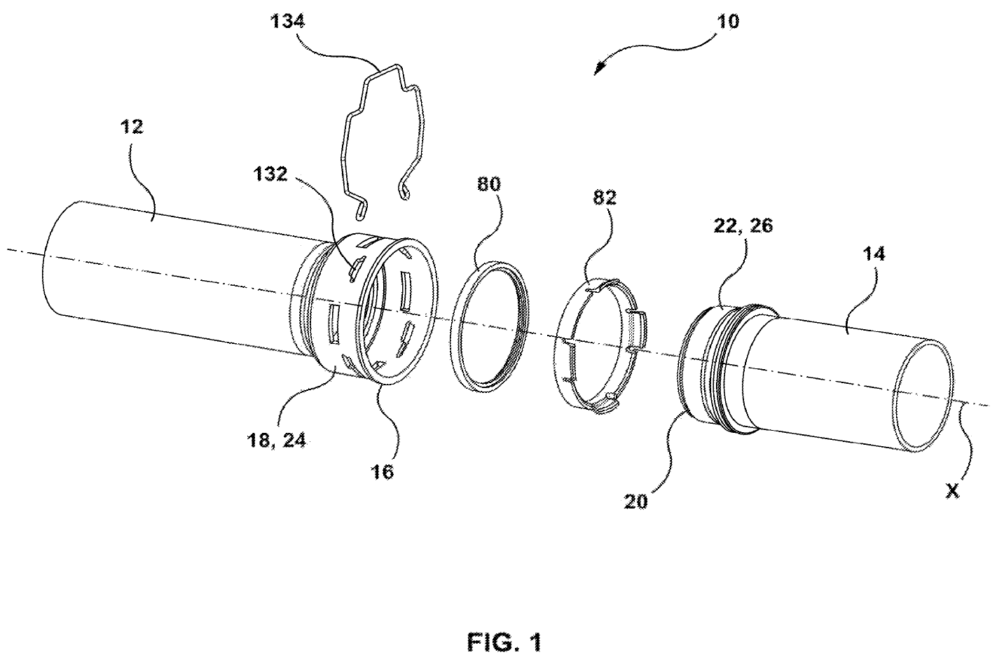

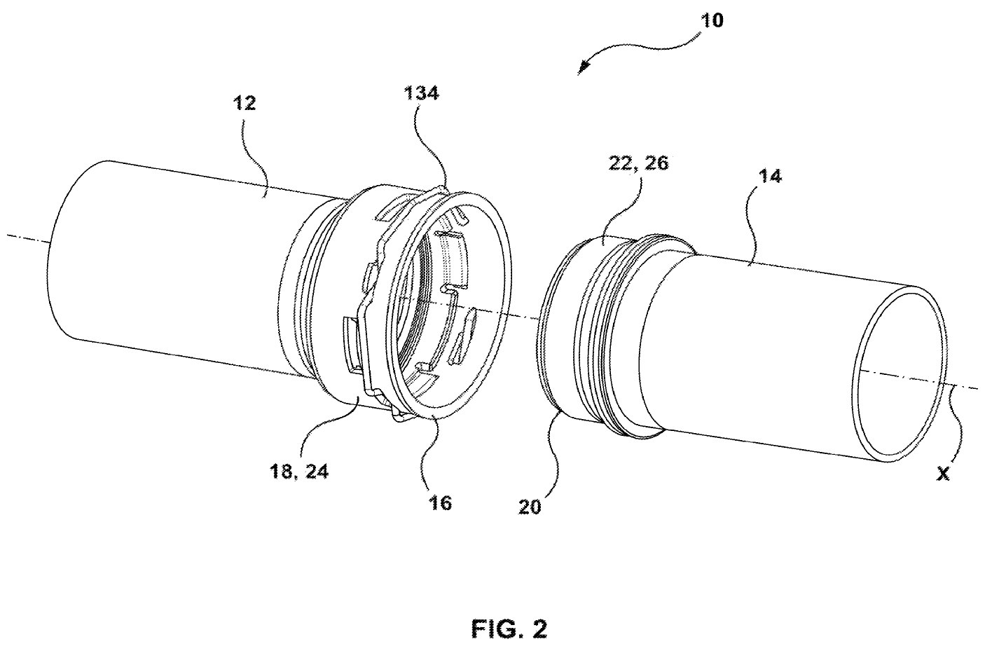

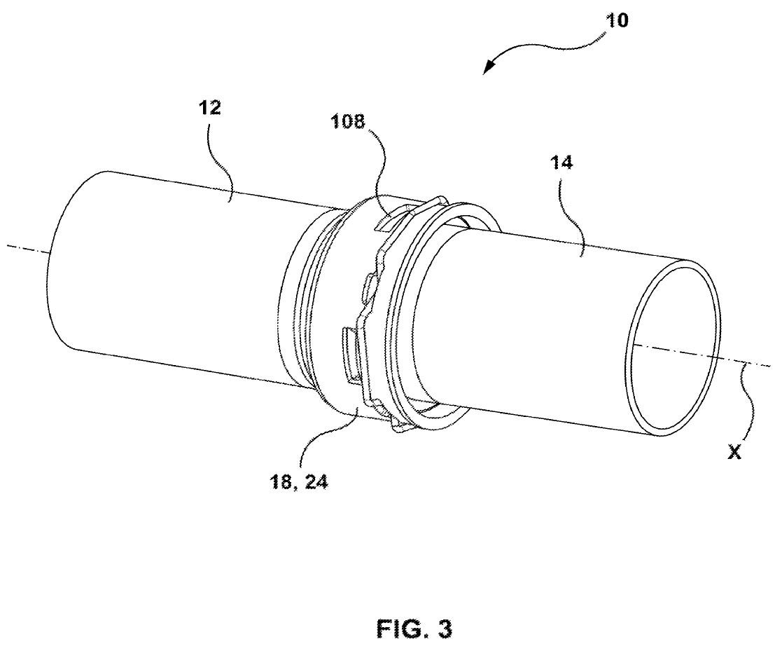

The coupling 10 shown in FIGS. 1 to 3 serves to interconnect a first pipe element 12 and a second pipe element 14, which are generally coaxial with respect to an axis X. The first pipe element 12 includes at a terminal end 16 a first coupling member 18, while the second pipe element 14 includes at a terminal end 20 a second coupling member 22. The first coupling member 18 is shown in the form of a female socket 24, while the second coupling member 22 is shown in the form of a cooperating male plug 26. The socket 24 is dimensioned to receive therein the plug 26, thus achieving in a coupled state a fluid communication between the first and second pipe elements 12, 14. In the embodiment shown, the first and second coupling members 18, 22 are integrally formed (i.e. molded) to the respective first and second pipe elements 12, 14. It will be appreciated that in some embodiments, the first and second coupling members 18, 22 may be separately formed, and subsequently attached to the respective first and second pipe elements 12, 14.

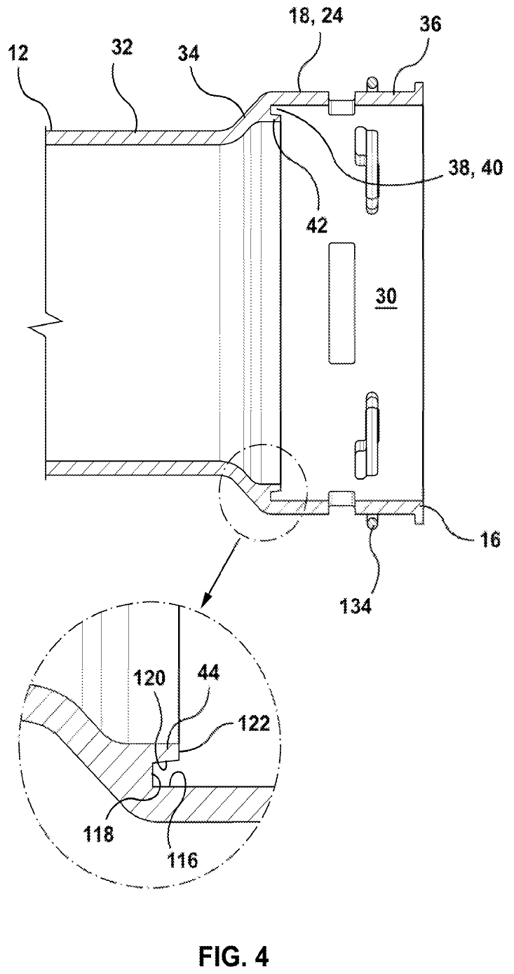

With reference now to FIG. 4, the socket 24 included on the first coupling member 18 includes a cylindrical cavity 30 located adjacent a first cylindrical portion 32 of the first pipe element 12. The cylindrical cavity 30 includes a divergent frustoconical wall 34, and a second cylindrical portion 36. The frustoconical wall 34 demarcates the region where the inside diameter of the first pipe element 12 increases between adjacent wall portions, in the direction towards the terminal end 16. Continuing with the first coupling member 18, also included is a seal pocket 38 for receiving at least a portion of an annular sealing element, as will be discussed in greater detail below. The seal pocket 38 is shown in the form of an annular channel 40 positioned at the transition between the frustoconical wall 34 and the second cylindrical portion 36. The channel 40 is delineated by an axially-directed seal channel wall 42.

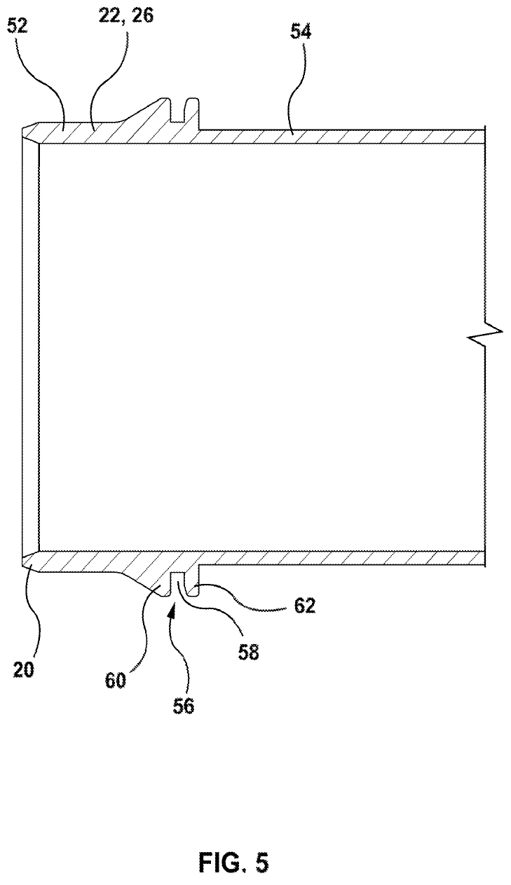

With reference now to FIG. 5, the plug 26 included on the second coupling member 22 includes a third cylindrical portion 52 and a fourth cylindrical portion 54. The third and fourth cylindrical portions 52, 54 are separated by a lock feature 56 that permits the plug 26 to be releasably locked relative to the socket 24, when the coupling 10 is in the coupled state. The lock feature 56 includes an annular ring channel 58 formed between a radially-directed first lock wall 60 and a radially directed second lock wall 62. As shown, the first lock wall 60 is ramped towards the terminal end 20 of the second coupling member 22, to facilitate assembly. Continuing with the second coupling member 22, in the embodiment shown, the third cylindrical portion 52 is enlarged on the exterior side compared to the fourth cylindrical portion 54. Stated differently, the inside diameter through the second pipe element 14 in the region of the second coupling member 22 remains constant, while the outside diameter of the third cylindrical portion 52 is greater than the outside diameter of the fourth cylindrical portion 54. This transition from the larger outside diameter of the third cylindrical portion 52 to the smaller outside diameter of the fourth cylindrical portion 54 is disposed at the lock feature 56. In general, the inside diameter through the second pipe element 14 will be similar to the inside diameter of the first pipe element 12 (as shown), although there may be instances where differences in the inside diameter may be desired, for instance where the coupling is used in a reducer-type configuration.

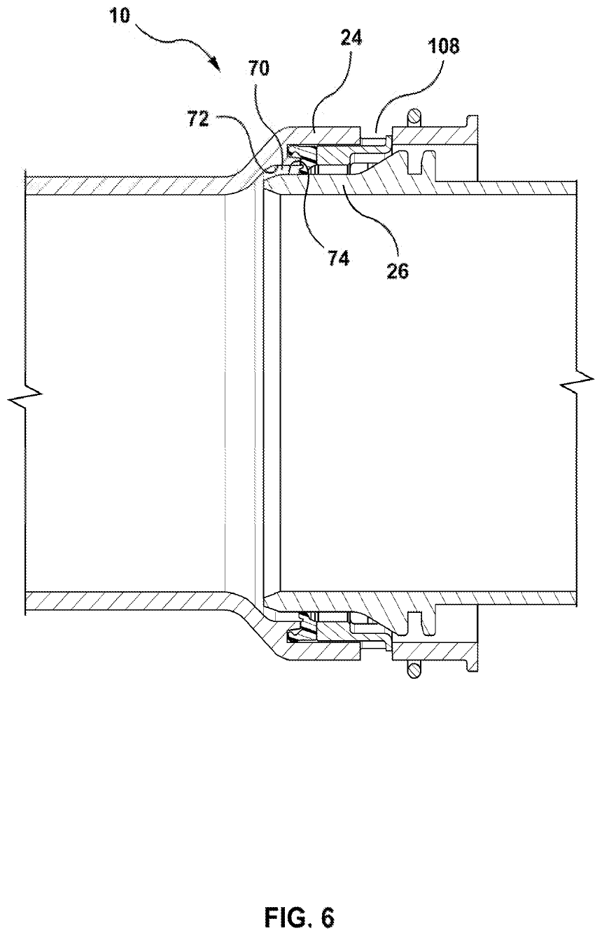

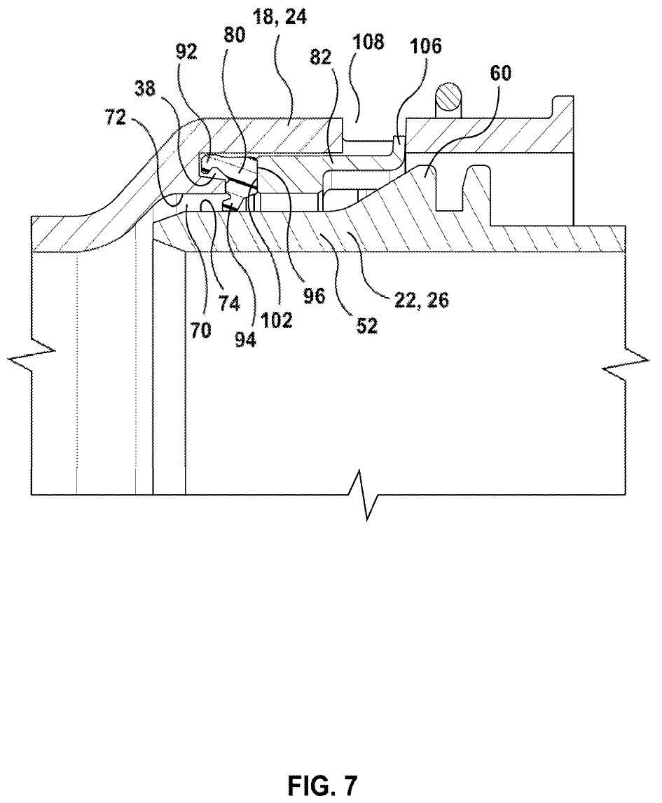

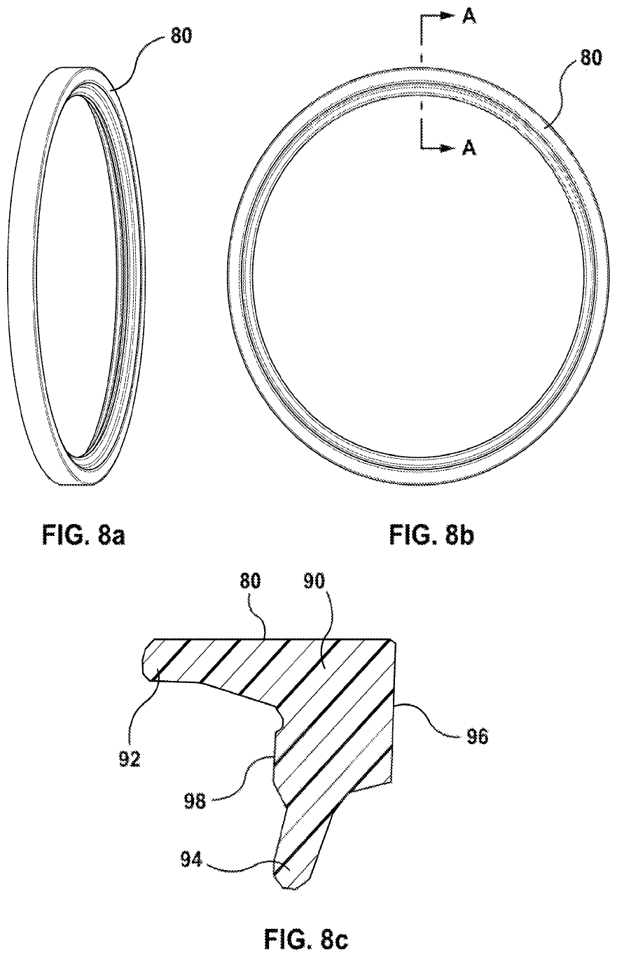

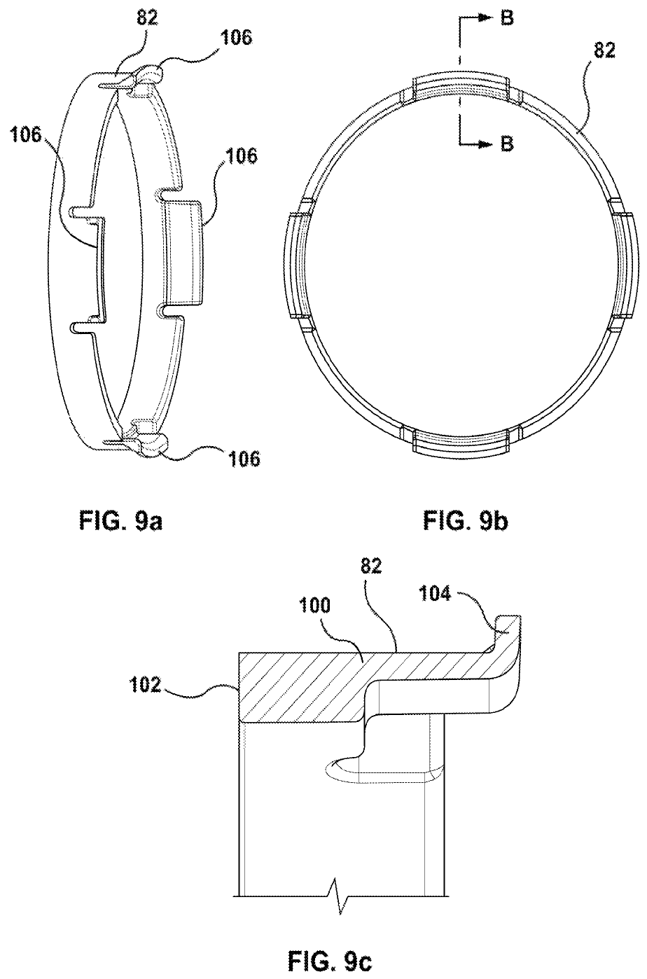

With reference now to FIG. 6, the coupling 10 in a coupled state defines an annular gap 70 between an inner peripheral surface 72 of the socket 24, and an outer peripheral surface 74 of the plug 26. To prevent the ingress and egress of air or fluids through the annular gap 70, the annular gap 70 includes a seal interface. The seal interface 76 is detailed in FIG. 7 and is shown to include the aforementioned seal pocket 38 of the first coupling member 18, as well as an annular sealing element 80 and an annular sealing element retainer 82. The annular sealing element 80 is shown in isolation in FIGS. 8a, 8b, and 8c, and the annular sealing element retainer 82 is shown in isolation in FIGS. 9a, 9b, and 9c.

With reference to FIG. 8c, the annular sealing element 80 includes a main body 90, a first sealing finger 92 and a second sealing finger 94. The annular sealing element 80 additionally includes a first compression surface 96 and a second compression surface 98. With reference to FIG. 9c, the annular sealing element retainer 82 includes a retainer main body 100, a sealing element engagement surface 102 and a retainer lock 104. In this embodiment, all elements detailed above with respect to the sealing element 80 and the retainer 82 are shown as annular structures, that is generally continuous about each respective structure, with the exception of the retainer lock 104. As best shown in FIG. 9a, the retainer lock 104 is a discontinuous annular structure, having a plurality of separate retainer lock segments 106. Each of the retainer lock segments 106 correspond to a respective retainer lock opening 108 on the socket 24, as shown for example in FIGS. 6 and 7.

With reference to FIG. 7, the annular sealing element 80 and retainer 82 are shown in the installed configuration. In this arrangement, the retainer 82 serves to maintain the annular sealing element 80 under compression against the socket 24. The annular configuration of the retainer 82 additionally serves to more evenly distribute the compression force, therein improving the circularity of the sealing function. This is achieved by positioning the retainer 82 internally of the coupling 10, within the cylindrical cavity 30, and dimensioning it with an axial-directed length that upon locking, presses the sealing element engagement surface 102 of the retainer 82 against the first compression surface 96 of the annular sealing element 80, thereby pressing the first sealing finger 92 into one or more surfaces of the seal pocket 38. Locking of the retainer 82 is achieved by seating the retainer lock segments 106 within the corresponding retainer lock openings 108 of the socket 24, to prevent unintentional removal. The one or more surfaces of the seal pocket 38 that may engage the first sealing finger 92 includes a first pocket seal surface 116, a second pocket seal surface 118 and a third pocket seal surface 120 (see FIG. 4). The retainer 82 additionally serves to impart a sealing contact between a channel wall surface 122 of the seal channel wall 42 and the second compression surface 98 of the annular sealing element 80.

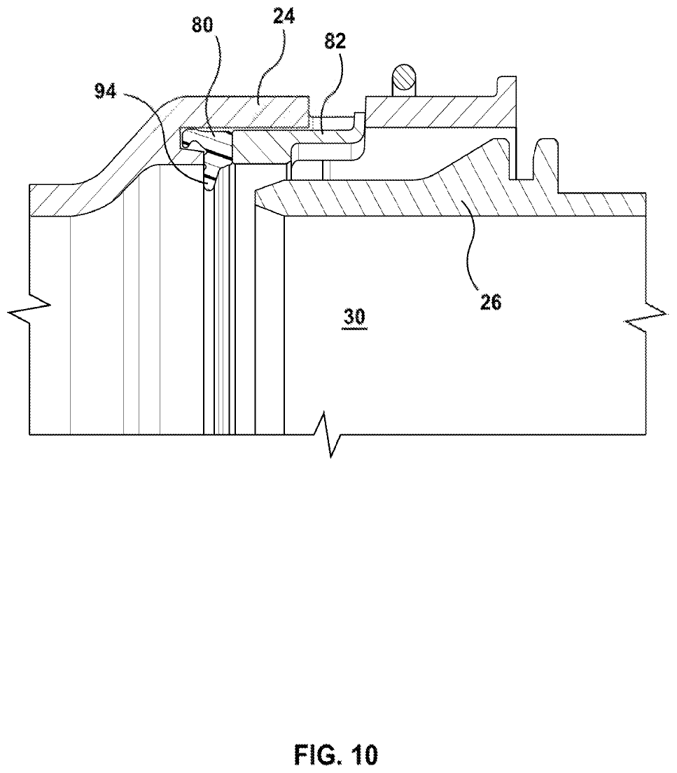

The retainer 82 serves to maintain the annular sealing element 80 in place within the socket 24 independent of whether or not the plug 26 is in position. FIG. 10 shows the socket 24 prior to coupling of the coupling 10, that is prior to the insertion of the plug 26 into the socket 24. The second sealing finger 94 is shown to extend generally radially inwards into the cylindrical cavity 30. With reference now to FIG. 7, the coupling 10 is shown with the plug 26 fully inserted, and it is evident that in this arrangement the second sealing finger 94 of the annular sealing element 80 engages and seals against the outer peripheral surface 74 of the third cylindrical portion 52 of the plug 26. Accordingly, by virtue of the sealing action of the annular sealing element 80 against portions of both the inner peripheral surface 72 of the socket 24, and the outer peripheral surface 74 of the plug 26, the annular gap 70 is effectively sealed to reduce the likelihood of ingress and egress of air or fluids therethrough.

It will be appreciated that the precise arrangement of the engagement surfaces between the sealing element 80 and the sealing element retainer 82 may be modified in some embodiments, to refine in certain circumstances the sealing performance of the sealing element within an assembled coupling. For instance, while the interface between the sealing element engagement surface 102 of the retainer 82 and the corresponding first compression surface 96 of the annular sealing element 80 is shown to be largely flat/planar, this interface may be modified depending on the selected profile of the sealing element.

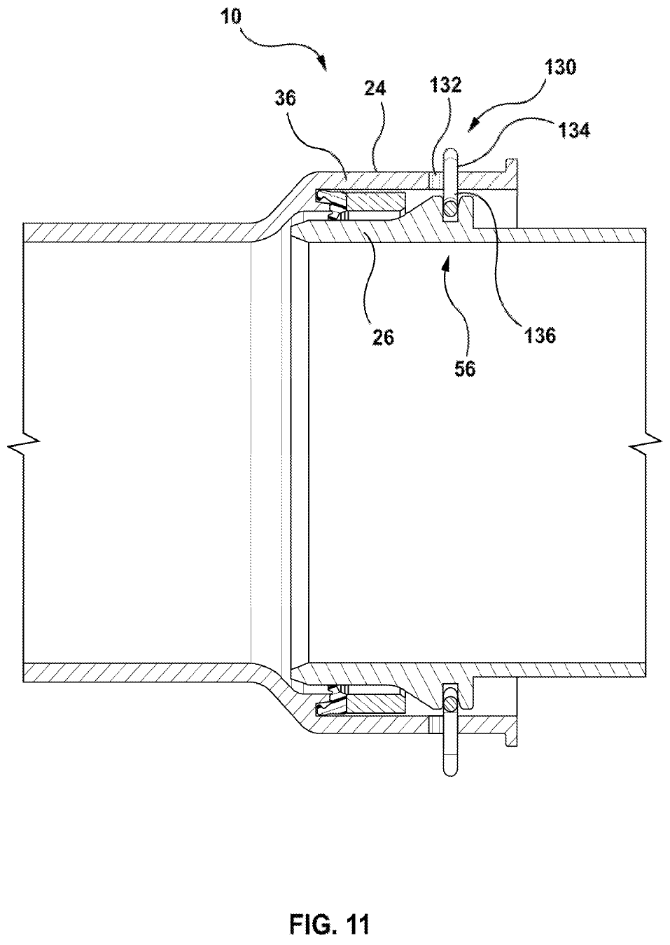

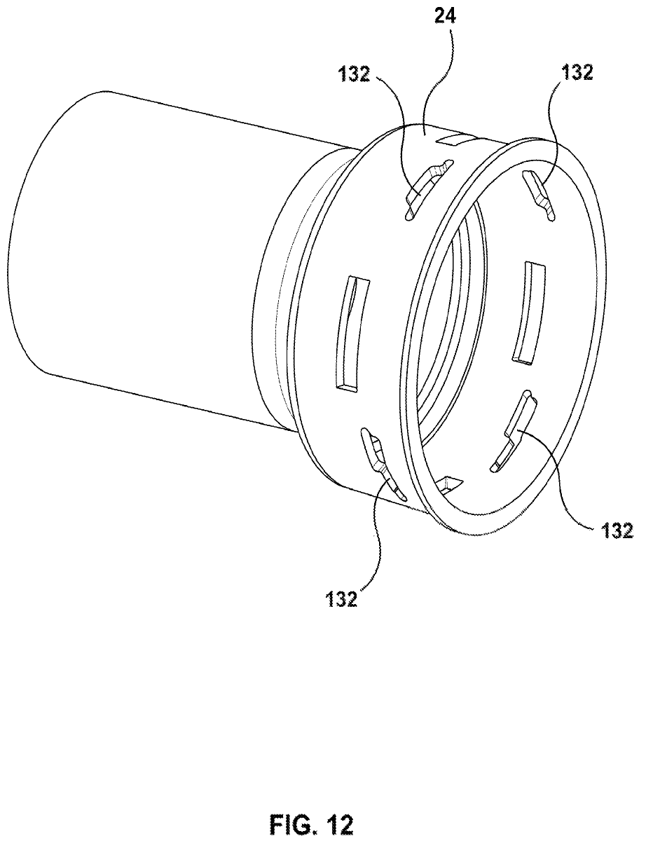

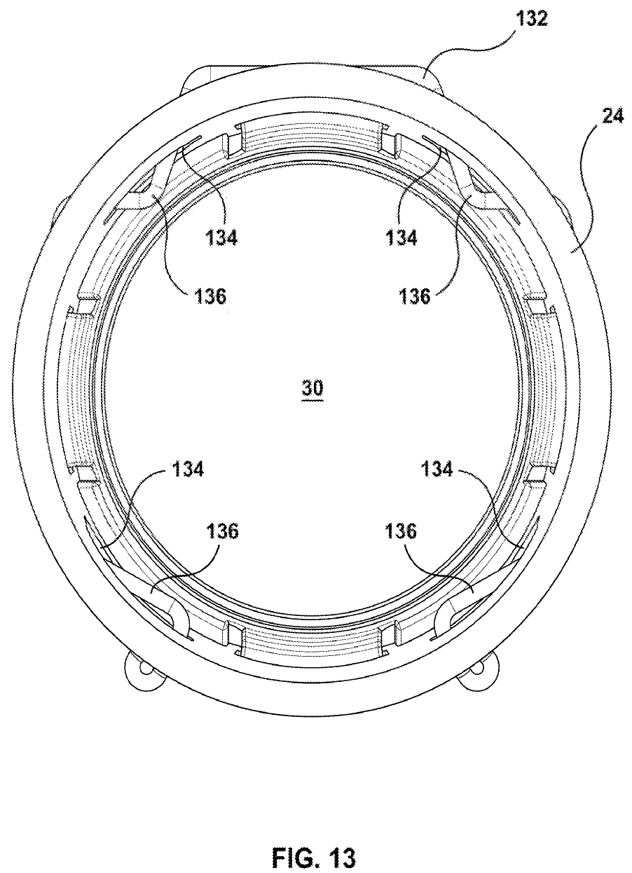

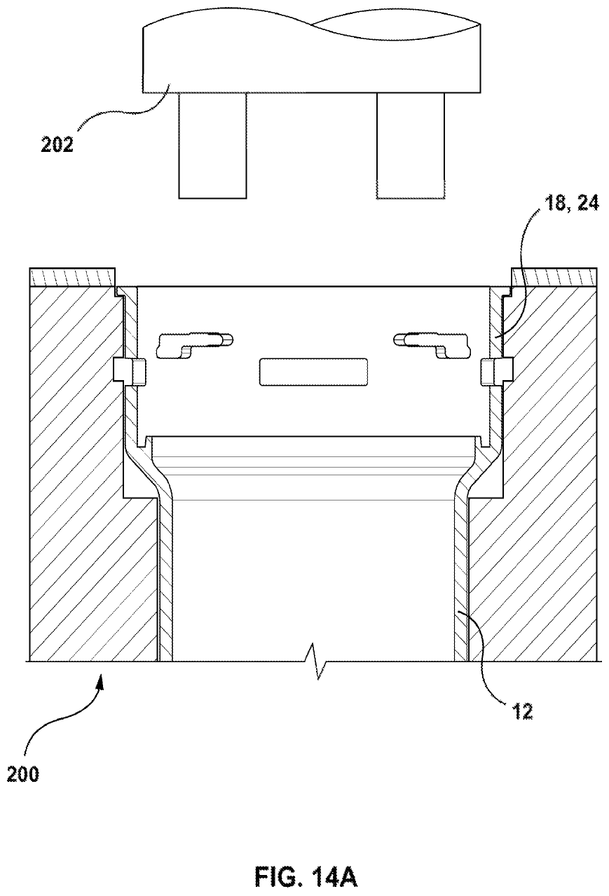

With reference now to FIG. 11, shown is the coupling 10 maintained in the coupled state, that is where the plug 26 of the second coupling member is inserted and fully seated within the socket 24 of the first coupling member 18 through a releasable locking mechanism 130. The locking mechanism 130 includes the lock feature 56 of the plug 26, a series of slits 132 included around the second cylindrical portion 36 of the socket 24, and a locking ring 134. As shown for example in FIG. 12, the socket 24 includes 4 slits 132 dimensioned to receive the locking ring 134 in a manner that permits at least a portion of the locking ring 134 to pass through each slit 132 into the region of the cylindrical cavity 30. The extent by which the locking ring 134 extends into the cylindrical cavity 30 is shown for example in FIG. 13. These portions of the locking ring 134 that extend into the cylindrical cavity 30, herein referred to as the locking portions 136 engage the lock feature 56 of the plug 26 (as shown for example in FIG. 11), therein preventing inadvertent removal of the plug 26 from the socket 24, that is until the locking ring 134 is intentionally removed.

In the fully coupled state, that is with the plug 26 fully seated within the socket 24, the retainer 82 holding the annular sealing element 80 in place cannot unlock. With reference to FIG. 7, in the fully coupled state, the retainer lock segments 106 cannot dislodge from the respective retainer lock openings 108 included in the socket 24 due to interference against the ramped first lock wall 60. Similarly, in the event the retainer 82 is not correctly installed, resulting in the retainer lock segments 106 not being correctly seated in the respective retainer lock openings 108, the plug 26 will not be able to fully seat within the socket 24, again due to interference between the retainer lock segments 106 and the ramped first lock wall 60. This aspect ensures a correct installation of the annular sealing element 80, as well as a proper seating of the plug 26 relative to the socket 24 during coupling of the coupling 10.

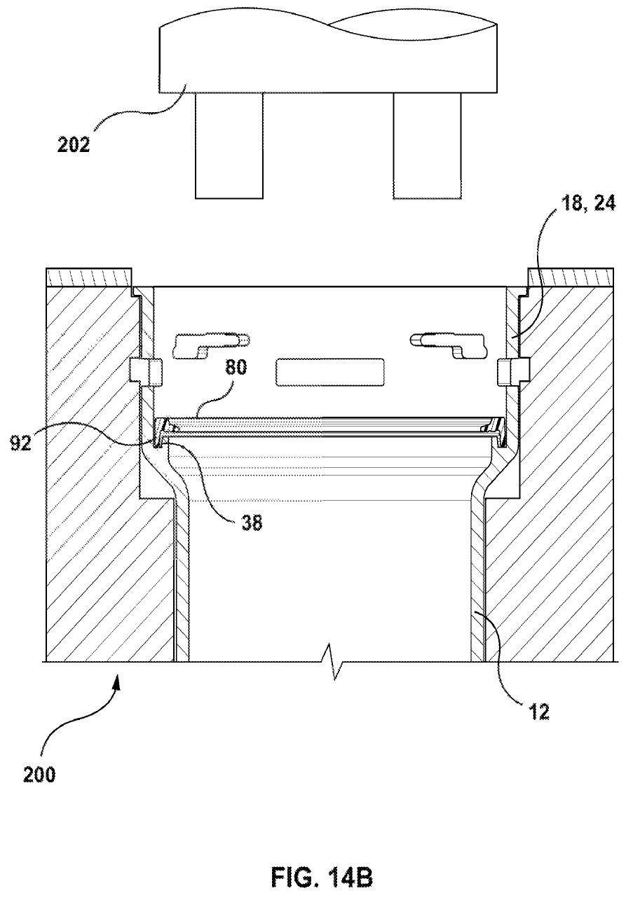

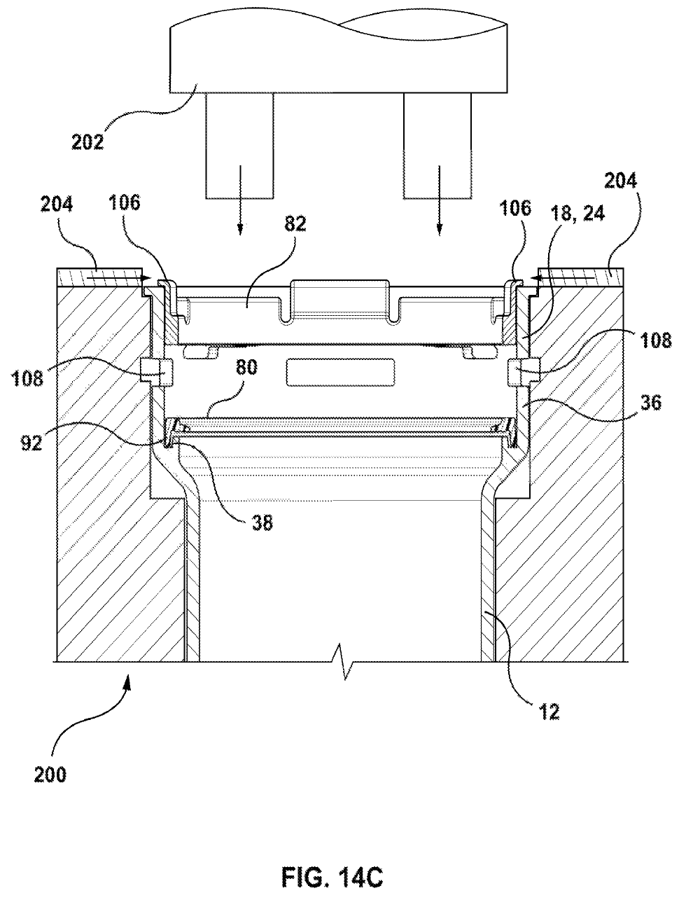

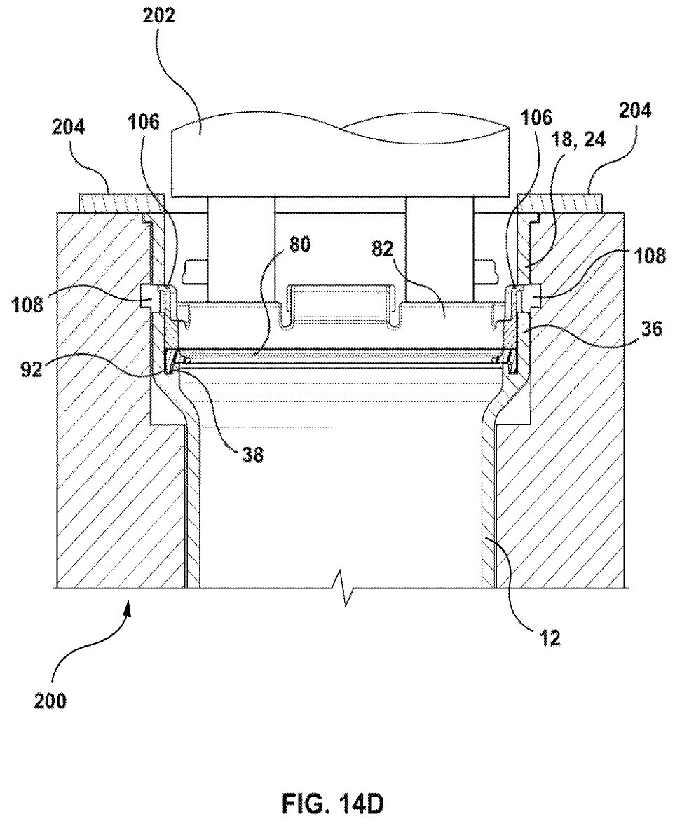

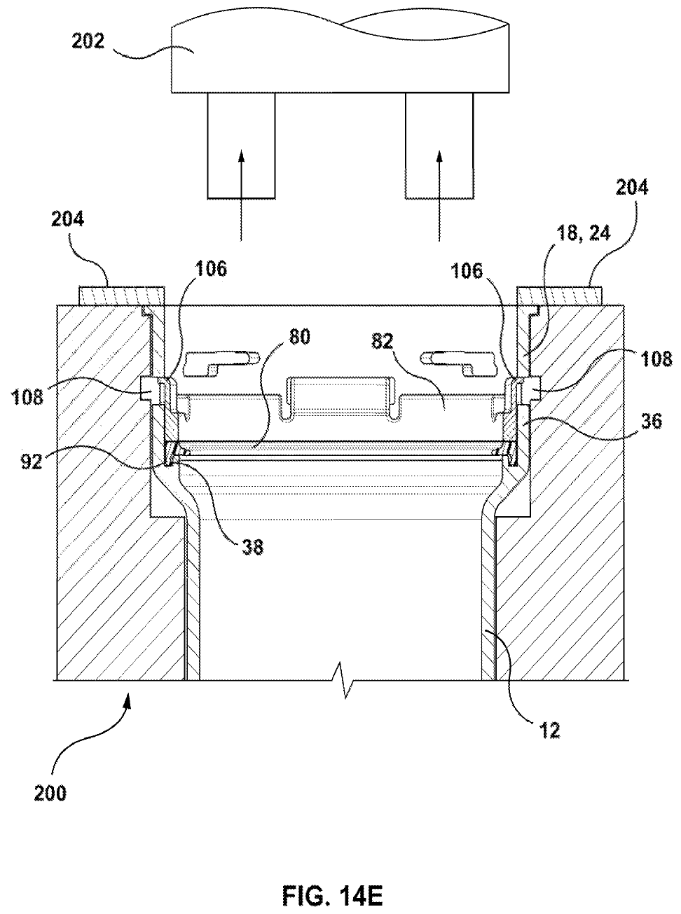

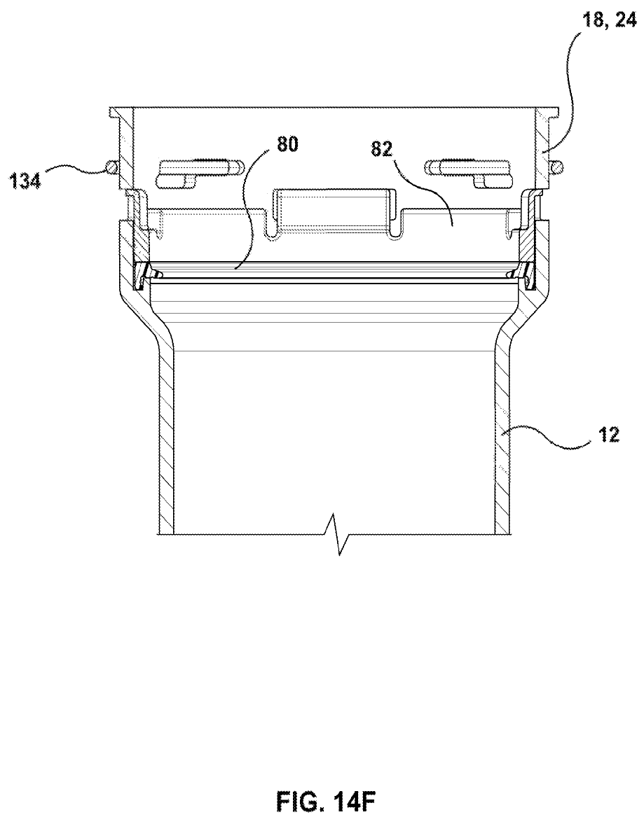

As previously mentioned, the annular sealing element 80 is preinstalled in the socket 24 and is maintained in position in a compressed state by way of the retainer 82. The following is a description of the process steps for the installation of the annular sealing element 80:
STEP 1 (see FIG. 14a): The first pipe element 12 is arranged in a fixture 200 such that the first coupling member 18, and in particular the socket 24 is positioned to face a plunger mechanism 202.
STEP 2 (see FIG. 14b): The annular sealing element 80 is inserted into the cylindrical cavity 30 of the socket 24 and located so as to position the first sealing finger 92 proximal the seal pocket 38.
STEP 3 (see FIG. 14c): The retainer 82 is set upon the terminal end 16 of the socket 24, and a slide actuator 204 of the fixture 200 compresses each of the retainer lock segments 106 radially inwards sufficiently to temporarily clear the inside diameter of the second cylindrical portion 36 of the socket 24. On setting the retainer 82 upon the terminal end 16, the retainer lock segments 106 are arranged to axially align with a corresponding retainer lock opening 108 of the socket 24.
STEP 4 (see FIG. 14d): The plunger mechanism 202 included on the fixture 200 presses the retainer 82 into the second cylindrical portion 36 and axially displaces it until it seats against the annular sealing element 80. The retainer 82 is fully locked when each of the retainer lock segments 106 spring into their original position, and are seated with the corresponding retainer lock opening 108.
STEP 5 (see FIG. 14e): The plunger mechanism 202 is retracted from the socket 24 and the first pipe element 12 is removed from the fixture 200.
STEP 6 (see FIG. 14f): The locking ring 134 is installed on the socket 24 in a manner that aligns the locking portions 136 to the slits 132.

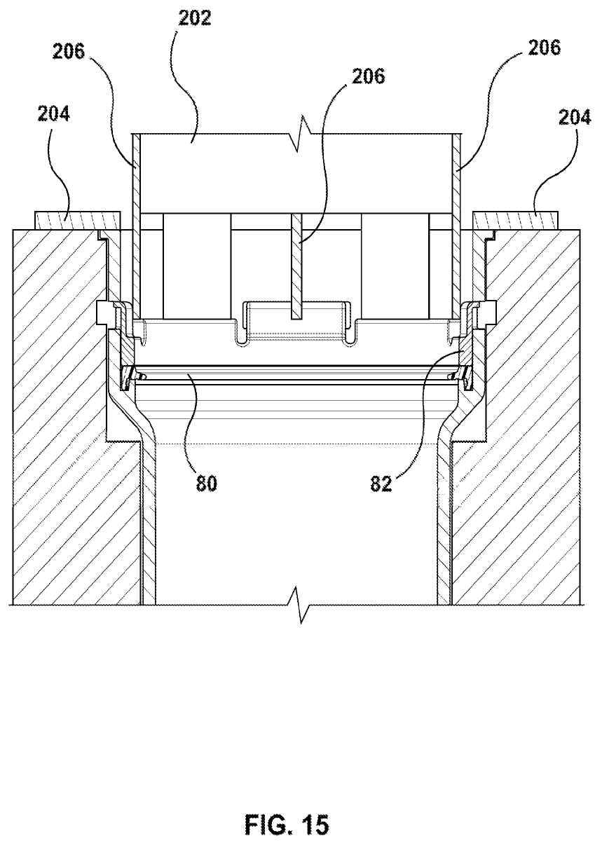

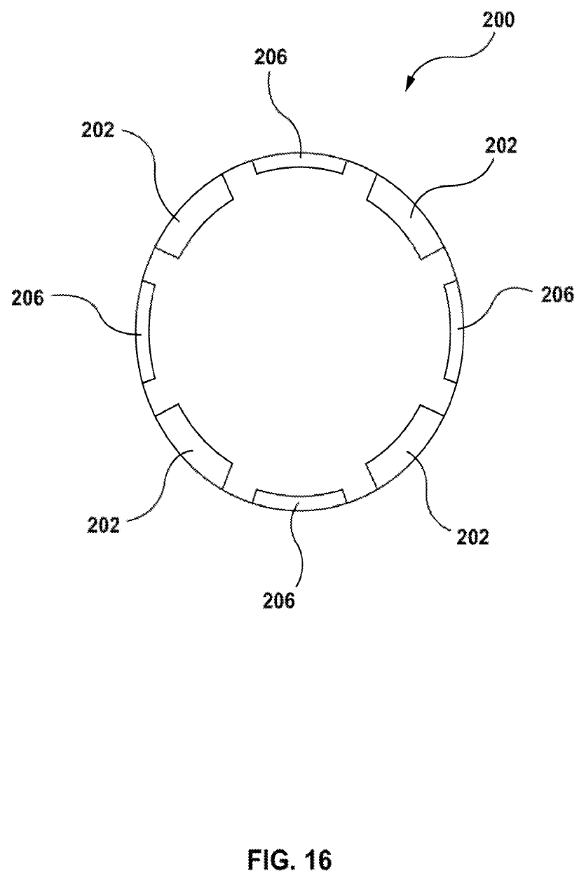

With reference to FIGS. 15 and 16, the fixture 200 may be configured to include a “poke-yoke”feature, to ensure proper positioning and seating of the retainer 82. As shown, the “poke-yoke” feature is configured as a depth slide 206 that is calibrated to detect the targeted placement of the retainer 82 within the socket 24. Only upon detection of the correct placement depth of the retainer 82 will the plunger be withdrawn from the socket 24, permitting the first pipe element 12 to be removed from the fixture.

A range of suitable materials may be used to form the first and second pipe elements 12, 14, in particular the socket 24 and plug 26 components, as well as the retainer 82, the selection of which will depend on the required performance characteristics. Exemplary materials include, but are not limited to polypropylene, polyethylene, nylon, polyphenylene ether (PPE), polyphenylene sulfide (PPS), polyamide (PA), polybutylene terephthalate (PBT), and combinations thereof. The annular sealing element 56 will generally be selected from an elastomeric material, including but not limited to a thermoplastic elastomer (TPE), ethylene propylene diene monomer (EPDM), silicone, or the like, and for higher heat applications the material may be a fluoroelastomer material (FKM). Metal parts, such as the locking ring 134 may be formed of stainless steel, aluminum or any suitable alternative having required flexibility.

In the discussion above, the first and second pipe elements 12, 14 are generally regarded as conduits as may be used in the air intake system of an automotive engine. It will be appreciated, however, that the coupling as described herein may find application in other areas outside the automotive arts, including but not limited to aviation, marine, and industrial air supply systems.

It is important to note that the construction and arrangement of the features in the various exemplary embodiments is illustrative only. Although only a few embodiments have been described in detail in this disclosure, those skilled in the art who review this disclosure will readily appreciate that many modifications are possible (e.g. variations in sizes, dimensions, structures, shapes and proportions of the various elements, values of parameters, mounting arrangements, use of materials, colors, orientations, etc.) without materially departing from the novel teachings and advantages of the subject matter herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications changes and omissions may also be made in design, operating conditions and arrangement of the various exemplary embodiments without departing from the present scope of the disclosure. It will also be understood that each feature of each embodiment discussed herein, and of each reference cited herein, can be used in combination with the features of any other combination. All patents and publications discussed herein are incorporated by reference herein in their entirety.

1. A coupling for interconnecting sections of pipe, the coupling comprising:
a first pipe element having a first coupling member in the form of a female socket;
a second pipe element having a second coupling member in the form of a male plug, the socket of the first pipe element being dimensioned to receive therein the plug of the second pipe element; and
a seal interface to prevent passage of air or fluids through an annular gap between the socket of the first coupling member and the plug of the second coupling member,
the seal interface including a sealing element and a sealing element retainer,
wherein the sealing element retainer is positioned internally of the coupling, within a cylindrical cavity of the socket.

2. The coupling according to claim 1, wherein the cylindrical cavity of the socket is located adjacent a first cylindrical portion of the first pipe element, the cylindrical cavity including a divergent frustoconical wall and a second cylindrical portion, the socket having a seal pocket at a transition between the frustoconical wall and the second cylindrical portion.

3. The coupling according to claim 1, wherein the sealing element retainer serves to maintain the sealing element under compression within the socket of the first coupling member independent of whether the plug of the second coupling member is coupled in position.

4. The coupling according to claim 2, wherein the sealing element retainer serves to maintain the sealing element under compression within the socket to promote sealing engagement between a portion of the sealing element and one or more surfaces of the seal pocket.

5. The coupling according to claim 2, wherein the sealing element includes a first sealing finger and a second sealing finger, the first sealing finger being arranged to engage and seal against one or more surfaces of the seal pocket of the socket, and the second sealing finger being arranged to engage and seal against an outer peripheral surface of the plug when the coupling is in a fully assembled state.

6. The coupling according to claim 1, wherein the sealing element and the sealing element retainer are generally annular in configuration, with the sealing element retainer having a retainer main body, a sealing engagement surface that engages a corresponding portion of the sealing element, and a retainer lock.

7. The coupling according to claim 6, wherein the retainer lock of the sealing element retainer is a discontinuous annular structure, having a plurality of separated retainer lock segments, and wherein each of the separated retainer lock segments correspond to and seats within a respective retainer lock opening in the socket of the first coupling member.

8. The coupling according to claim 1, wherein the first and second coupling members are integrally formed to the respective first and second pipe elements.

9. The coupling according to claim 1, wherein the first and second coupling members are separately formed, and subsequently attached to the respective first and second pipe elements.

10. The coupling according to claim 1, further comprising a releasable locking mechanism to prevent inadvertent removal of the plug from the socket.

11. The coupling according to claim 10, wherein the releasable locking mechanism includes a locking ring that includes locking portions that pass through corresponding slits on the socket to extend into the cylindrical cavity, where the locking portions engage a corresponding lock feature on the plug.

12. A process for the installation of an annular sealing element in a first pipe element, the process comprising:
arranging in a fixture a first pipe element having a female socket, the first pipe element being positioned in a manner that aligns the socket to face a plunger mechanism;
inserting into the socket an annular sealing element;
placing a sealing element retainer within the socket in a manner that axially aligns a series of retainer lock elements with a corresponding retainer lock opening of the socket;
using a slide actuator of the fixture to compresses the retainer lock segments radially inwards sufficiently to temporarily clear an inside diameter of the socket;
axially displacing the plunger mechanism so as to seat the sealing element retainer against the annular sealing element, sealing element retainer being fully locked when each of the retainer lock segments spring into their original position, and are seated within the corresponding retainer lock opening of the socket;
retracting the plunger mechanism from the socket; and
removing the first pipe element from the fixture.
